(19) United States
(12) Patent Application Publication
(10) Pub. No.: US 2015/0288979 A1
(43) Pub. Date: Oct. 8, 2015

(54) VIDEO FRAME RECONSTRUCTION

(71) Applicants: Liu YANG, Shanghai (CN); INTEL CORPORATION, Santa Clara, CA (US)

(72) Inventor: Xin Feng Dong, Shanghai (CN)

(21) Appl. No.: 13/977,803

(22) PCT Filed: Dec. 18, 2012
(86) PCT No.: PCT/CN12/86811

§ 371 Date: Jul. 1, 2013

(51) Int. Cl. H04N 19/51; H04N 19/172; H04N 19/137; H04N 19/176; H04N 19/159

(52) U.S. Cl. CPC H04N 19/51; H04N 19/176; H04N 19/159; H04N 19/137; H04N 19/172

(57) ABSTRACT

Systems and methods may provide for a video encoder that reconstructs a video frame. A number of initial reconstructed macro block lines may be generated by encoding initial reconstructed macro block lines from a first buffer holding a current frame. The initial reconstructed macro block line may be placed in a FIFO buffer sized to hold the initial reconstructed macro block lines. An additional reconstructed macro block line can be generated by encoding the next line in the current frame using at least one reconstructed macro block line in the FIFO buffer. A re constructed macro block line pulled from the tail of the FIFO buffer maybe placed sequentially in a reference buffer. After all the number of lines in the current frame have been processed, the additional reconstructed macro block lines may be pushed onto the head of the FIFO buffer.

### BACKGROUND

Digital video is widely used for various purposes including, for example, video entertainment, video advertisements, video conferencing, and sharing of user-generated videos. More devices are using video encoding and decoding technologies to comply with various constraints including, for example, bandwidth or storage requirements. Video compression schemes include formats such as VPx (promulgated by On2 Technologies, Inc. of Clifton Park, N.Y.), H.264 standard promulgated by ITU-T Video Coding Experts Group (VCEG) and the ISO/IEC Moving Picture Experts Group (MPEG), including present and future versions thereof. H.264 is also known as MPEG-4 Part 10 or MPEG-4 AVC (formally, ISO/EC 14496-10). The and other example video encoding and decoding technologies may have to opiate on devices with limited resources, such as internal memory, such as smart phones, tablets, computers, and/or the like.

Many video coding techniques use block based prediction and quantized block transforms. With block based prediction, a reconstructed frame buffer maybe used to predict subsequent frames. Conventional reconstructed frame buffers, however, may require relatively large amounts of memory to operate.

### BRIEF DE SCRIM ON OF THE DRAWINGS

The various advantages of the embodiments of the present invention will become apparent to one skilled in the art by reading the following specification and appended claims, and by referencing the following drawings, in which:

FIG. 1 illustrates an exam* video system using an aspect of an embodiment of the present invention;

FIG. 2 is a block diagram of an example of a video encoder as per an aspect of an embodiment of the present invention;

FIG. 3 is a block diagram of an example of a video encoder configured to perform key frame encoding as per an aspect of an embodiment of the resent invention;

FIG. 4A is a block diagram of an example of a video encoder configured to perform non-key frame encoding as per an aspect of an embodiment of the present invention;

FIG. 4B is a block diagram of an example of a video encoder configured to perform an alternative non key frame encoding as per an aspect of an embodiment of the present invention;

FIG. 5 is a block diagram of an example of a VP8 video encoder configured to perform a non-key frame encoding as per an aspect of an embodiment of the present invention;

FIG. 6 is a block diagram of an example of a VP8 video encoder configured to perform an alternative non-key frame encoding as per an aspect of an embodiment of the present invention;

FIGS. 7A and 7B are illustrations of an example of FIFO buffers employed dining a non-key frame encoding as per an aspect of an embodiment of the present invention;

FIG. 8 is a flow diagram of an example of video frame encoding as per an aspect of an e mbodiment of the present invention;

FIG. 9 is an flow diagram of an example of non-key frame encoding as per an aspect o fan embodiment of the present invention; and

FIGS. 10 and 11 are illustrations of embodiments of the present invention.

### DETAILED DESCRIPTION

Embodiments of the present invention re construct a non-key video frame using a FIFO (first in first out) buffer. Specifically, embodiments of the resent invention maybe used to save me moving by allocating one comparatively small buffer to store reconstructed macro block (MB) lines instead of allocating a whole frame buffer.

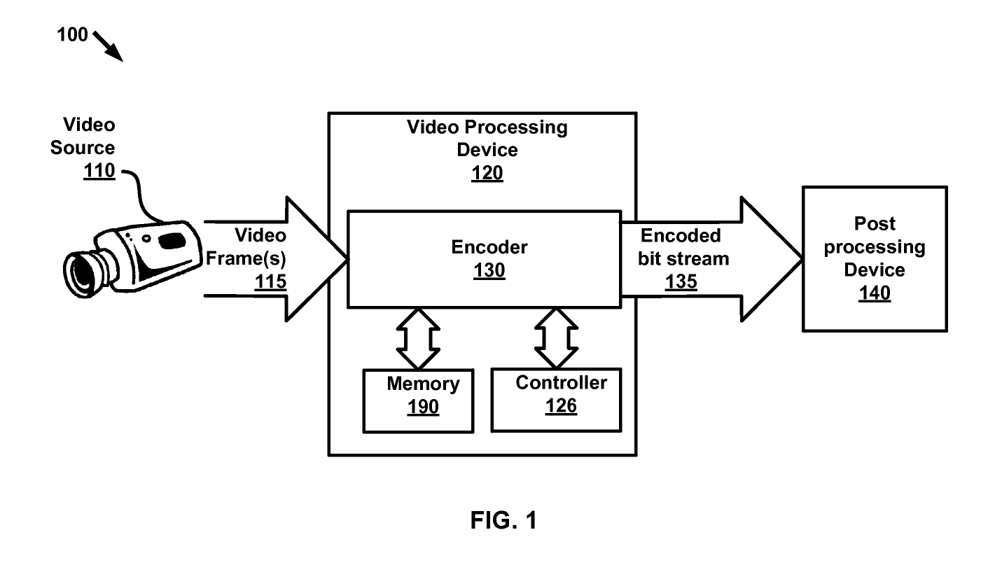

Video is the technology of electronically capturing, recording, processing, sharing, transmitting, and reconstructing a sequence of still images representing scenes in motion. FIG. 1 illustrates an example video system using an aspect of an embodiment of the present invention. Typically, in a video system, a video source 1 10 may provide a video signal in the form of a series of video frames 115 to a video processing device 120. The video processing device 120 may include, among other components, an encoder 130, memory 190, and a controller 126.

The controller 126 may be a chip, an expansion card, a stand-alone device, a combination thereof, and/for the like that interfaces and may control other devices such as a peripheral device. The controller 126 may link between puts of a computer (for example a memory controller that manages access to memory 190 or a video encoder 130). In a computing device, the controller maybe a plug-inboard, single integrated circuit on the motherboard, or an external device.

The output of the encoder maybe an encoded bit stream 135 that is transported to a post processing device 140. Examples of a post processing device may include a storage device, a transport device (to transport the encoded bit stream 135 to other decoder devices through network or other transport path), a computers a sewer, a combination thereof, and/or the like.

The video frames maybe provided at a frame rate. The frame rate may be the number of frames (or pictures) per unit of time of video, typically ranging from six or eight frames per second (frame's) for older systems to 120 or more frames per second for newer systems. The minimum frame rate to achieve the illusion of a moving image maybe approximately fifteen frames per second.

Video may be transmitted or transported employing a variety of techniques including as a digital signal as a wireless broadcast, over a coaxial cable system, a fiber optic system, a wired system (e.g. telephone, twisted-pair cable, differential twisted pair cable), a digital retwork (e.g. intra-net, Internet), a combination thereof, and/or the like.

Video transmission mechanisms may have bandwidth and other limitations that restrict the amount of information that may be transported over a period of time. To overcome these limitations, a wide variety of methods may be used to compress video streams. Video data contains spatial and temporal redundancy, making uncompressed video streams extremely efficient. Broadly speaking, spatial redurdancy maybe reduced by registering differences between parts of a single frame. This task maybe known as intra-frame compression and is closely related to image compression. Likewise, temporal redundancy may be reduced by registering differences between frames; this task is known as inter-frame compression and may include motion compensation and other techniques. Many video compression algorithms and codecs combine spatial image compression and temporal motion compensation. Common modern standards for compression include, but are not limited to: MPEG-x (e.g. MPEG-2 and MPEG-4), H.264, and VPx (e.g. VP9).

Many video compression algorithms use glossy compression where data may be eliminated with relatively perceptually indistinguishable results. In using lossy compression, there may be a tradeoff between video quality, cost of processing the compete scion and de compete scion, and system requirements.

A frame in which a complete image maybe stored in the data steam is a key frame, also known as an intra-frame. Only changes that occur from one frame to the next may be stored in the data stream to greatly reduce the amount of information that is stored. This technique capitalizes on the fact that most video sources (such as a typical movie) have only small changes in the image from one frame to the next. Wherever a drastic change to the image occurs, such as when switching from one camera shot to another, or at a scene change, a key frame maybe created. The entire image for the frame maybe output when the visual difference between the two frames is so great that representing the new image incrementally from the previous frame would be more complex and would require even more bits than reproducing the whole image.

Non-key frames may store incremental changes between frames. In other words, data for a given non-key frame may only re present how that frame was different from the preceding frame. For that reason, key frames maybe inserted at intervals while encoding video. To represent low that frame was different from the preceding frame, video compression may opiate on square-shaped groups of neighboring pixels, often called macro blocks. The pixel groups or blocks of pixels maybe compared from one frame to the next and the video compression code c may send only the differences within those blocks. In areas of video with more motion, the compression may encode more data to keep up with the larger number of pixels that are charging. Quality changes based on the amount of video change may decrease or increase a variable bit rate. For example, a compression format that operates with macroblocks is VP8, created by On2 Technologies and purchased by Google Inc. in 2010.

Like H264/AVC, VP8 adopts multiple reference frames for motion estimation and compensation to provide coding efficiency and error concealment. Generally, there are three frame buffers allocated for reference (i.e. a golden frame buffer, an alternative frame buffer, and a last (or previous) frame buffer) as well as one buffer for the current re constructed frame Embodiments o f the presently claimed invention may reduce the number of required frame buffers, reducing hardware cost especially in some memory constrained devices.

It may have been proposed in research to reduce memory requirement for storing frames by reducing the reference frames' size by down-sampling or recompressing frames. These approaches, however, may introduce a “drift” error coming from miss-matched data due to the encoder and decoder utilizing different reference data for motion compensation. Additionally, the approaches may take a great amount of computational complexity due to employing additional encoder and decoder for coding every reconstructed picture. Embodiments of the presently claimed invention can reduce the memory-size on the reconstructed buffer instead of the reference frames.

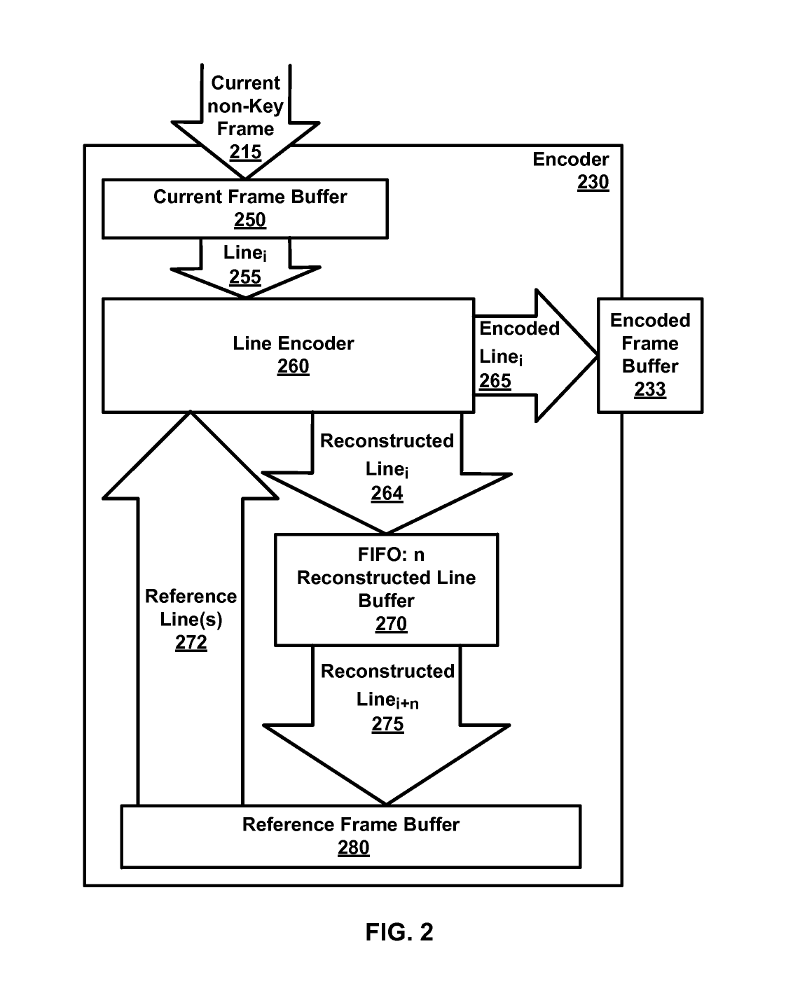

FIG. 2 is a block diagram of an encoder 230 configured to reconstruct a non-key video frame 215 as per an aspect of an embodiment of the present invention. The illustrated encoder includes a first buffer 250, a line encoder 260, a first in first out (FIFO) buffer 270 and a reference frame buffer 280.

The first buffer 250 maybe a current frame buffer to hold a current frame, wherein the current frame may be a non-key frame 215 desclosing change information for a number of lines 255. The change information may be describe movement of macro blocks from the previous frame.

The line encoder 260 may generate a reconstructed macro block line 264 for each of the number of lines 255. The line encoder 260 may generate encoded line(s) 265 using a current line 256 from the current frame 215 (in the current frame buffer 250) and at least one reconstructed reference line 272 in the first in first out buffer 270 until all of the number of lines have been processed. The line encoder 260 maybe part of an encoder such as, for example, a VP8 encoder.

The first in first out buffer (FIFO) 270 may be sized to hold the number of reconstructed macro block lines 264. The number of reconstructed macro block lines 264 the first in first out buffer (FIFO) 270 is sized to hold may be dependent upon the reconstruction algorithm. For example, in some cases the number of reconstructed macro block lines 264 maybe three. In yet other cases the number of reconstructed macro block lines 264 maybe greater than three, for example, sixteen or seventeen. The more reconstructed macro block lines 264 the FIFO buffer holds, the more macro blocks that will be available for the reconstruction of the current line 255.

According to some of the various embodiments, the first in lust out buffer 270 maybe part of a reference buffer 280. In other embodiments, the first in first out buffer 270 maybe dedicated buffer. The reference buffer 280 may include a previous frame buffer and/or an alternate flame buffer, as will be discussed in greater detail. The referent e buffer 28 0 may hold reconstructed macro block lines 275 output from the first in first out buffer 270.

The encoder 230 may be part of a system that includes additional components such as a video input and an encoded video output. The video input may accept the video frames 115 and may include receiving modules that incorporate hardware and/or software in combination with hardware. The receiving module may be configured to accept packetized digital video from a storage device or streamed.

The encoded video output may transport the encoded bit stream 135 to other devices or to modules within a system. The encoded video output may transport encoded line(s) 265 to an encoded frame buffer 233 or directly as an encoded bit stream 135 (FIG. 1) or encoded.

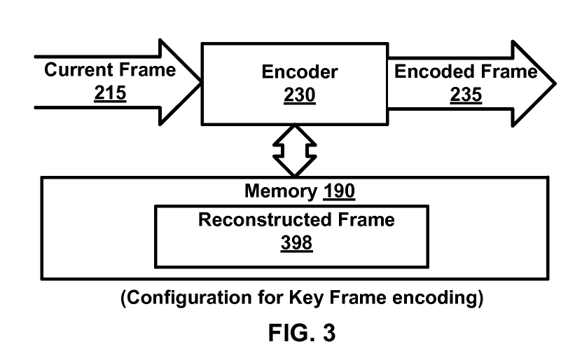

Four frame buffers may be allocated for an encoder such as a VP8 encoder. Three frame buffers for reference frames (Golden Rune buffer. Alternative Frame buffer, and Last Frame buffer). The fourth buffer for the current reconstructed frame 398. A common rule maybe defined to manage the reference buffers 491 to be refreshed or replaced after one frame is encoded and reconstructed. On one hand, there may be a need to reduce the memory size for some memory constrained scenarios. On the other hand, full use of the given frame buffers in many cases may not be utilized. Below, embodiments of the present invention utilizing the new memory scheme according to various embodiments will be introduced in terms of different cases. Firstly as illustrated in FIG. 3, if current frame is key frame, no reference frames may be needed and only or frame buffer may be required for current frame reconstruction. So any frame buffer allocated for referent e frames could be re-used for the reconstructed frame. Recalling that a key frame is a complete frame, encoder 230 may utilize in memory 190 a reconstructed frame buffer 398. In this case, where the current frame 215 is a key frame, the complete frame may be reconstructed into the reconstructed frame buffer 398.

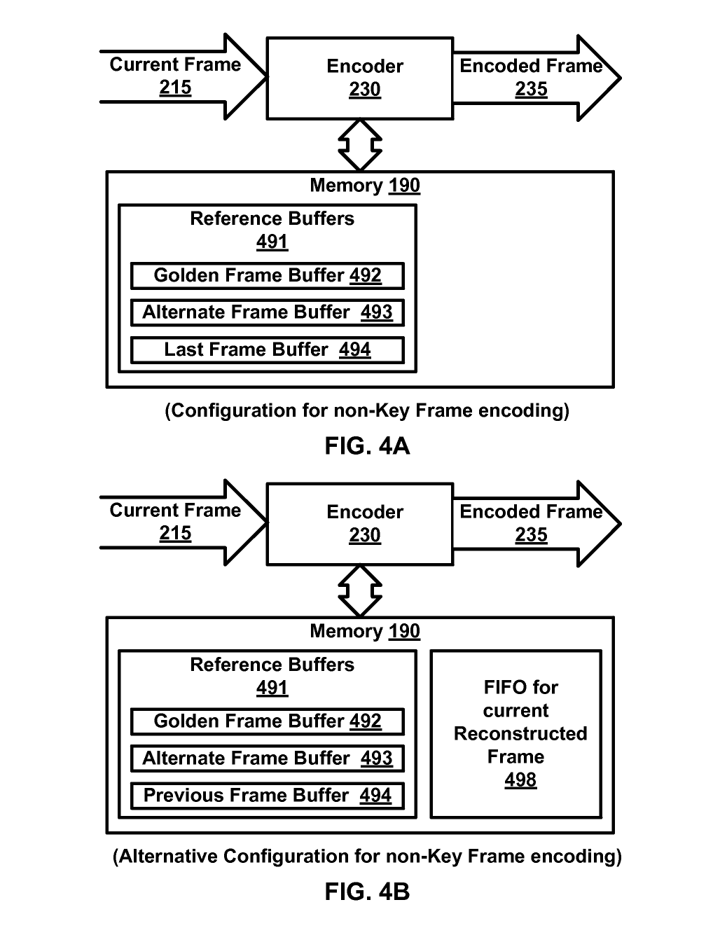

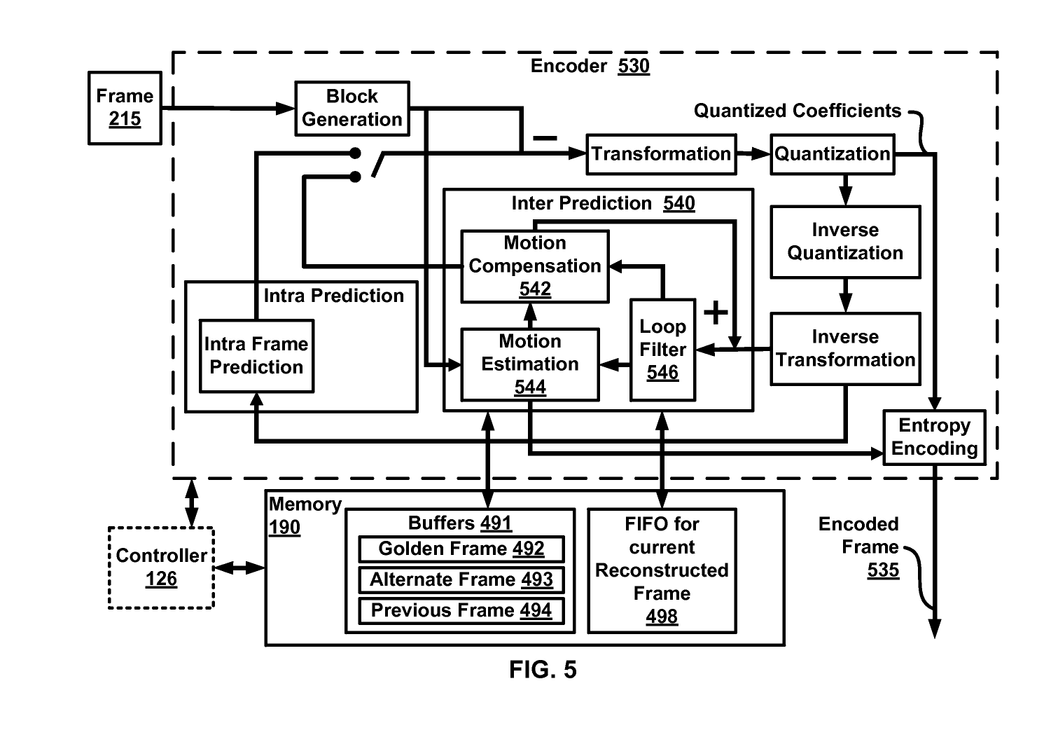

FIG. 4A illustrate a case were the current frame 215 is a non-keyframe. In this case, after the current frame 215 is encoded, if no frames in reference buffers 491 reed to be refreshed or replaced, a golden frame buffer 492, an alternative frame buffer 493 and a last frame buffer 494 maybe kept for the next frame. This means that there may not be a need to store the current reconstructed frame, making it unnecessareutecessary to allocate a frame buffer to store the whole picture while encoding. In the second, at least one of the reference buffers 491 may need to be replaced with the reconstructed frame, but at least one need-to-be replaced buffer may riot be in the reference list for current frame 215. In this case, the need-to-be replaced buffer could be directly used as the reconstructed buffer. Additionally, in this case, it may be unnecesary to allocate one frame buffer for the reconstruction.

FIG. 4B illustrate another non-key frame encoding case as per an aspect of an embodiment of the present invention In this cases, none of the existing reference buffers 491 maybe available for re-use directly for a current reconstructed frame. A comparatively small FIFO buffer 498 may be allocated to store reconstructed macro block lines instead of allocating one whole frame buffer.

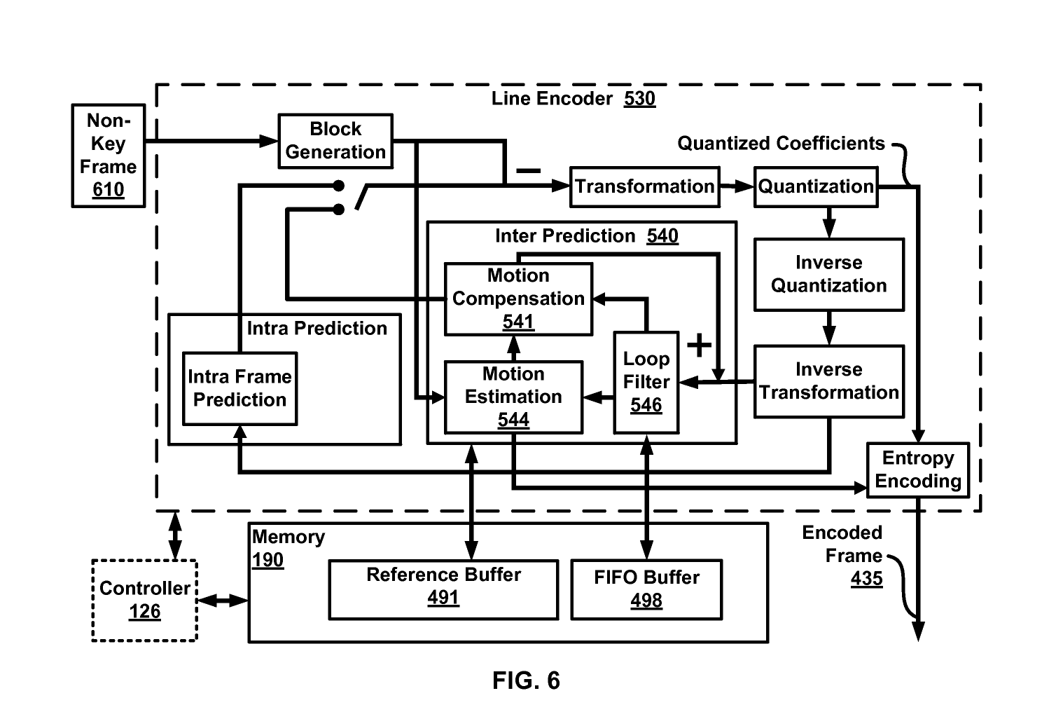

FIG. 5 is a block diagram of an example VP8 video encoder 530 configured to perform non-key frame encoding as per an aspect of an embodiment of the present invention. This diagram illustrates an example relationship between the reference buffers 491 and FIFO buffer 498 with respect to the encoder 530. Frame 215 may enter encoder 530 and be converted into an encoded frame 535. In the process of encoding, the encoder 530 may use an inter prediction module 540.

The inter frame prediction module 540 may exploit the temporal coherence between nearby frames. In doing this, inter frame prediction module 5.40 may access reference frames in buffers 491 and motion -vectors. The inter-frame types may include key frames and non-key frames (e.g. predicted frames). The key frames maybe de coded without reference to other frames and are sometimes used as seeking points in a vide o. The non-key frame decoding may depend on prior frames up to the last key frame. Prediction frame types : previous frame 494, alternative reference frame 493 and golden reference frame 492. Each of these three types may be used for prediction. The last frame 494 may contain the last fully decoded frame and may be updated with every shown frame. The alternative reference frame 493 maybe a fully decode d frame buffer that maybe used for noise reduced prediction and is often used in combination with golden frames 492. The golden reference frame 492 maybe use d as a fully decoded image buffer that maybe partially updated, used from error recovery, and/or used to encode a cut between scenes.

Key frames may update all three buffers 491 (previous frame 494, alternative reference frame 493 and golden reference frame 492). Non-key frames (predicted frames) may use a flag for updating alternate 493 or golden frame buffers 494.

Part of the inter prediction module 540 may include a motion estimation module 544, a motion compensation module 542, a loop filter 546, and/or the like. The motion estimation module 544 may determine motion vectors the transform one frame into another. Motion vectors maybe for groups of macro blocks such as 16×16 groups, 16×8 graups, 8×16 groups, 8×8 groups, 4×4 groups, and/or the like. The motion compensation module 542 may apply motion vectors to previous frames to generate a predicted frame.

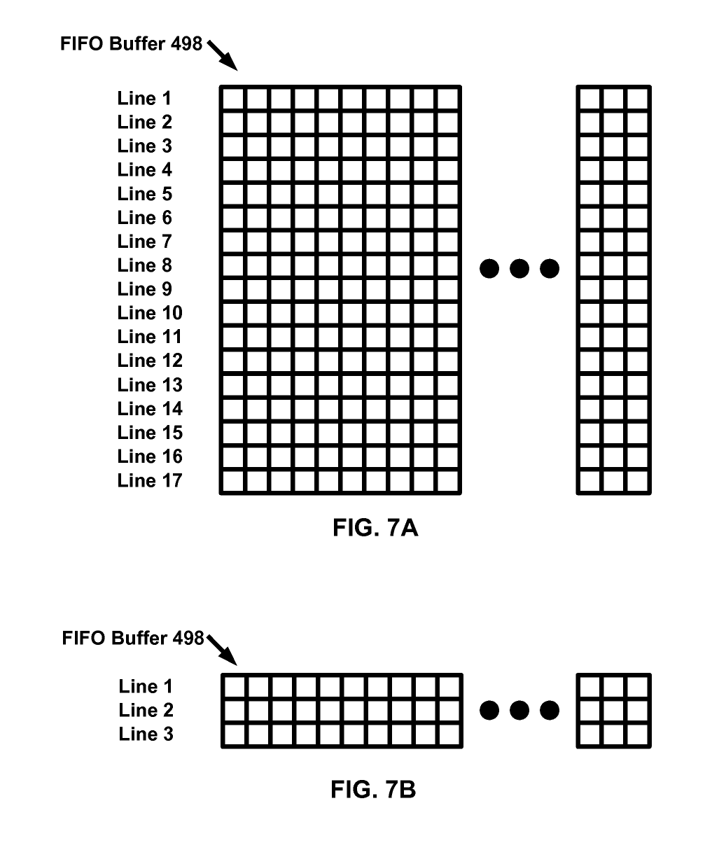

The loop filter 546 may be used to reduce visually objectionable blocking artifacts at the boundaries between macro blocks and between subblocks of the macro blocks. Loop filter 546 may have multiple filtering modes from normal to simple and with multiple levels of sharpness, strength, sensitivity and/or the like. These mode s maybe selected by flags and/or other methods such as external control, dynamic determination by content, and/or the like. The loop filter 546 may affect the reconstructed frame buffers that are used to predict ensuing frames. Loop filtering may be the last stage of frame reconstruction and the next-to-last stage of the decoding process. Therefore, according to some of the embodiments, the reconstructed macro block lines maybe output to the FIFO buffer 498 from the loop filter 546 as illustrated in FIG. 5 and FIG. 6. However, those skilled in the art will recognize that other locations in an encoder 530 maybe the source of reconstructed macro block lines such as an output from motion compensation module 442.

FIG. 6 is a block diagram of an example VP8 video encoder configured to perform an alternative non-key frame encoding as per an aspect of an embodiment of the present invention This scenario covers cases where there may not be any exist buffers that mag be re-used directly for a current reconstructed frame. In this case, one comparatively small FIFO buffer 498 may be used to store reconstructed macro block lines instead of a whole frame buffer. Reconstructed macro block lines may be moved into one reference buffer 491 to hold a complete reconstructed frame as they are processed.

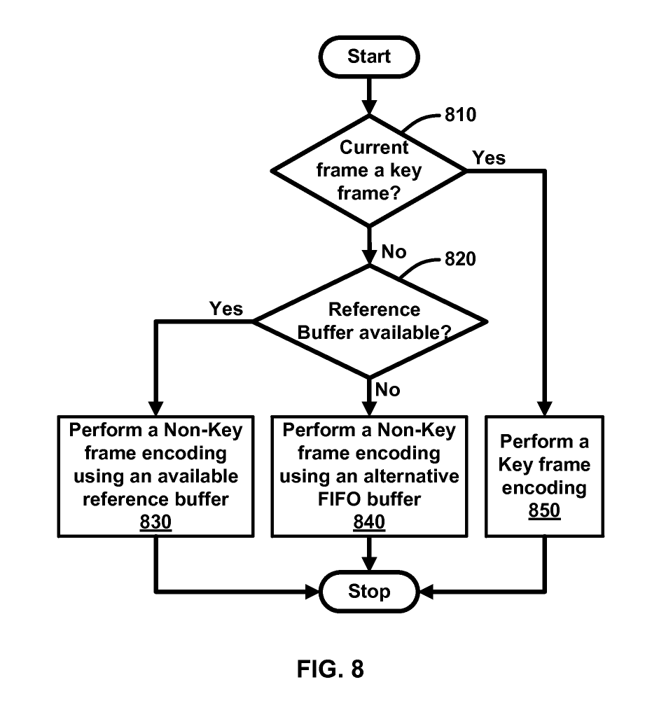

FIGS. 7A and 7B illustrate example FIFO buffers 498 with two different example sizes that maybe employed dining a non-key frame encoding as per an aspect of an embodiment of the present invention. Reining specifically to FIG. 7B, considering the motion estimation and motion compensation in range, the FIFO buffer 498 in this example embodiment may contain 17 MBs in height when the Maximum motion vector is 255. For 1080p contents, this maybe the size of ¼ of a frame buffer.

While encoding, the 17th macro block line maybe encoded first and the reconstructed macro block lines stored in FIFO buffer 498. The pixels in first macro block line maybe storedback to reference frame buffer 491 without impact on the motion estimation and motion compensation. After that, the macro block line (used to be the first one) maybe taken to store pixels of the next macro block line, and so forth, until the last macro block line is reconstructed. This example may require an additional memory copy from the alternate buffer to the reference buffer 491. However, encoders such as VP8 encoders are typically used for low motion video (e.g. video conference), where many macro blocks are directly derived from a reference and are so called “rot-coded” macro blocks. Several of the various embodiments may bypass the forward-direction copy (from reference to current reconstructed buffer), where instead only those reconstructed macro blocks will be stored back from the FIFO buffer 498. Statistics of low motion video show that forward-direction and backward-direction macro block level coping maybe relatively equal, so an extra copy may not be of concern relative to the benefit of memory savings in a memory constrained environment. Therefore, some of the various embodiments may save one or ¾ frame buffer for 1080p content without introducing additional impact on video quality. One skilled in the art will also recognize that various embodiments may be applicable to other video codecs in low-motion video usage with the FIFO buffer 498 size adjusted accordingly.

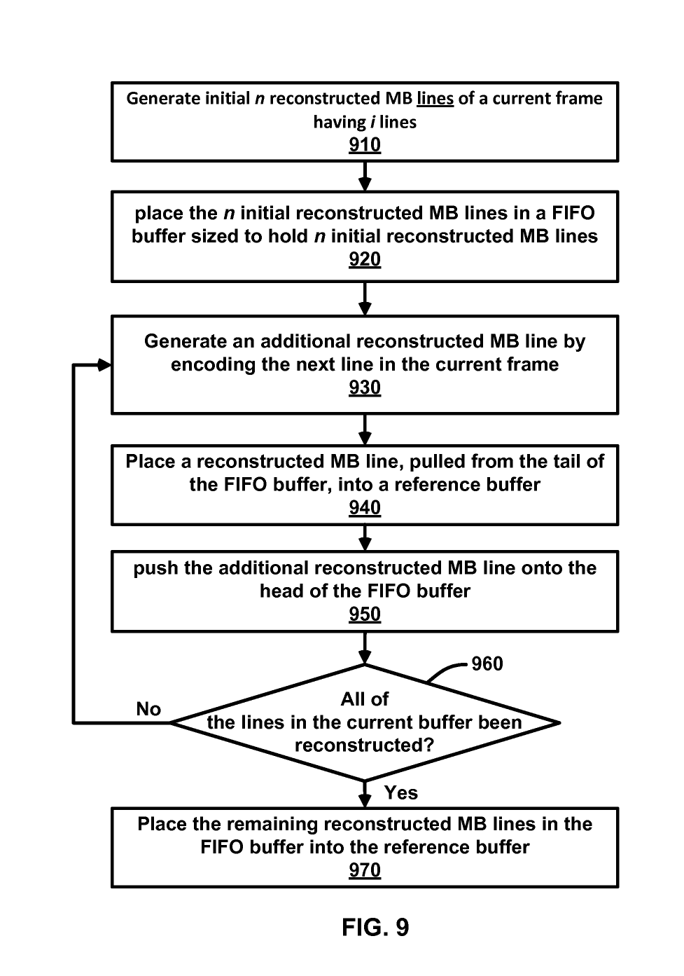

FIG. 8 is a flow diagram of video flame encoding as per an aspect of an embodiment of the present invention. At processing block 810, a determination maybe made as to whether a current frame is a key frame or a non-key frame. If the current frame is determined to be a key frame, then the frame may be encoded as a key frame at block 850. Since a key frame comprises a complete image, the frame maybe decoded without reference to other frames. If the frame was determined to be a non-key frame at block 810, then a determination as to whether any reference buffers are available for use as a FIFO buffer may be made at block 820. If the determination is positive, then a non-key frame encoding maybe performed using the available reference buffer at block 830. Examples of available reference buffers include previous frame buffer 494, alternative reference frame 493 and golden reference frame 492 (FIGS. 4A, 4B and 5). If the determination is negative, then a non-key frame encoding may be performed using an alternative FIFO buffer 498 (FIGS. 4A, 4B, and 6) at block 840.

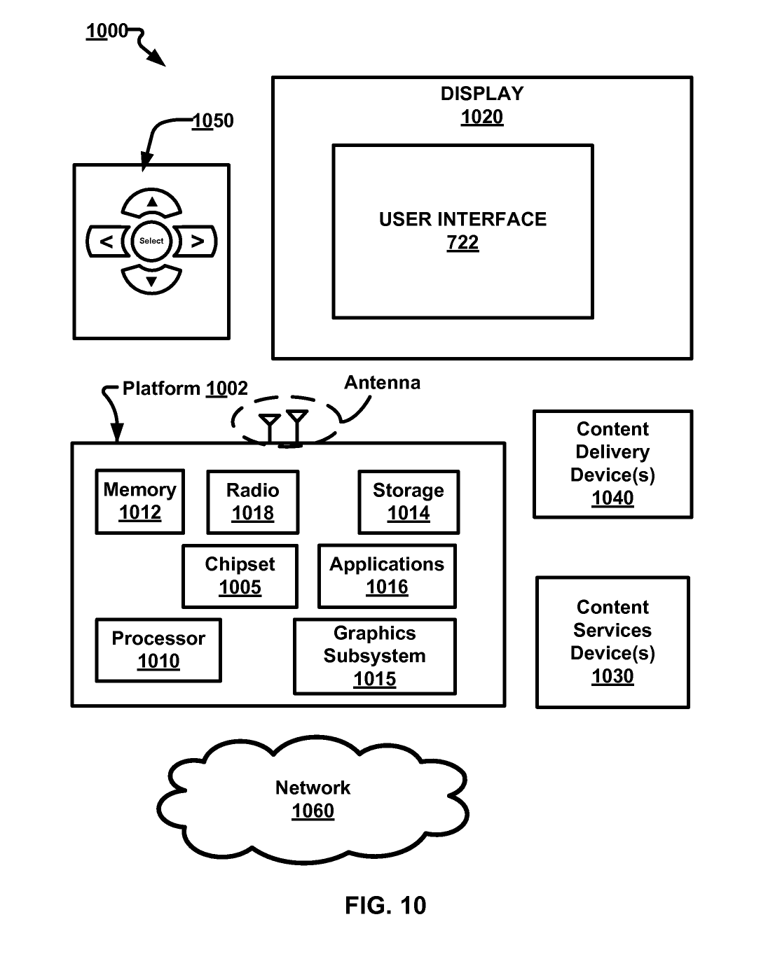

FIG. 9 is a flow diagram of an example encoder that maybe used to reconstruct a non-key video frame as per an aspect of an embodiment of the resent invention. A current frame having a number of lines (e.g. i) of video information may be input into a first buffer according to one of the various embodiments. At block 910, an initial number of reconstructed macro block (MB) lines (e.g. n) maybe generated by encoding n number of initial reconstructed macro block lines from the first buffer. The encoding may utilize all or part of an encoder such as a VP8 encoder. The n number of initial reconstructed macro block lines maybe /laced in a first in first out buffer that is sized to hold at least the n number of initial reconstructed macro block lines at block 9 20. Incrementally, a series of actions (blocks 930-960) maybe taken until all the number of lines in the current frame has been processed. At block 9 30 an additional reconstructed macro block line may be generated by encoding the next line in the current frame. A reconstructed macro block line pulled from the tail of the first in first out buffer may be placed sequentially into a reference buffer at block 940. The additional reconstructed macro block line may be rushed onto the head of the first in first out buffer at block 950. Once a determination that all the number of lines in the current frame buffer have been reconstructed at block 960, the remaining reconstructed macro block line(s) in the first in first out buffer maybe moved into the reference buffer at block 970.

Throughout the illustrated process, additional reconstructed macro block line(s) may be generated using the next line in the current frame and each reconstructed macro block line in the first in first out buffer. This approach may useful in cases that all of the reconstructed macro block line in the first in first out buffer would help to produce more ac curate reconstructed macro block line(s).

In some of the various embodiments, the number of initial reconstructed macro block lines maybe three. However, in yet other embodiments, the number n of initial reconstructed macro block lines maybe larger. This number n may depend upon the size of the video frame and the desired quality of the reconstructed macro block lines.

If there is an mailable reference buffer, then the first in first out buffer maybe part of an available reference buffer. The reference buffer in this case maybe one of a previous frame and an alternate frame buffer. Otherwise, the first out buffer maybe located in an additionally allocated block of memory or a dedicated memory segment.

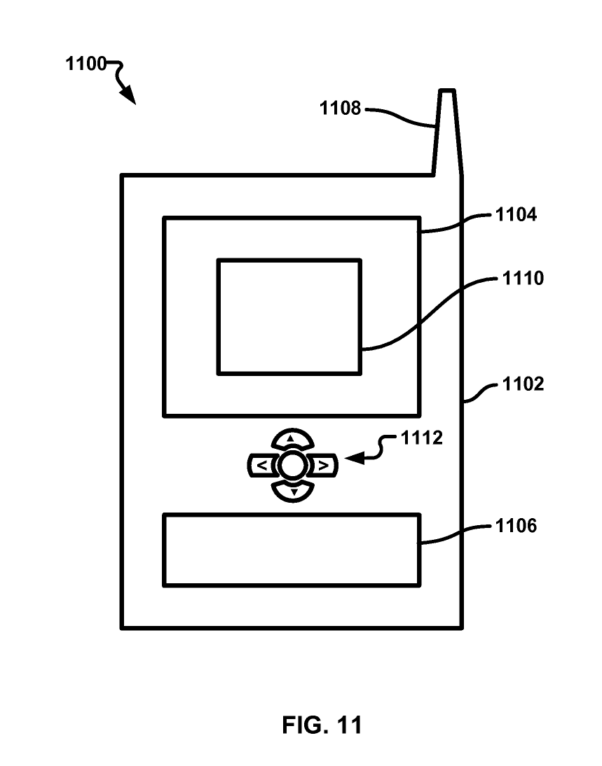

FIG. 10 illustrates an embodiment of a system 1000. In embodiments, system 1000 may be a media system although system 100 0 is not limited to this context. For example, system 1000 may be incorporated into a personal computer (PC), laptop computer, ultra.-laptop computer, tablet, touch pad, portable computer, handheld computer, palmtop computer, personal digital assistant (FDA), cellular telephone, combination cellular telephone/FDA, television, smart device (e.g., smart phone, smart tablet or smart television), mobile internet device (MID), messaging device, data communication &vice, and so forth.

In embodiments, system 1000 comprises a platform 1002 coupled to a display 1020. Platform 1002 may receive content from a content device such as content services device(s) 1030 or content delivery device(s) 10 40 or other similar content sources. A navigation controller 1 050 comprising or or more navigation features maybe used to interact with, for example, platform. 1002 and/or display 1020. Each of the se components is described in more detail below.

In embodiments, platform 1002 may comprise any combination of a chipset 1005, processor 1010, memory 1012, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as Complex Instruction Set Computer (CIS C) or Reduced Instruction Set Computer (RISC) processors, x86 instruction set compatible processors, multi-core, or any outer microprocessor or central processing unit (CPU). In embodiments, processor 1010 may comprise dual-core processors), dual-core mobile processors), and so forth.

Memory 1012 maybe implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but rot limited to, a magnetic disk chive, optical disk drive, tape chive, an internal storage device, an attached storage device, flash memory, battery backed-up SDRAM (synchronous DRAM), and/or a network accessible storage device. In embodiments, storage 1014 may comprise technology to increase the storage performance enhanced protection for valuable digital media when multiple hard drives are included, for example

Graphics subsystem 1015 may perform processing of images such as still or video for display. Graphics subsystem 101 5 maybe a graphics processing unit (GPU) or a visual processing unit (VPU), for example. An analog or digital interface maybe used to communicatively couple graphics subsystem 1015 and display 1020. For example, the interface may be any of a. High-Definition Multimedia. Interface. DisplayPort, wireless HDME, and/or wireless HD compliant techniques. Graphics subsystem 1015 could be integrated into processor 1010 or chipset 1005. Graphics subsystem 1015 could be a stand-alone card communicatively coupled to chipset 1005.

The graphic s and/or video processing techniques described herein may be implemented in various hardware architectures. For example, graphics and/or video functionality may be integrated within a chipset. Alternatively a discrete graphics and/or video processor may be used. As still another embodiment, the graphics and/or vide o functions maybe implemented by a general purpose processor, including a multi-core processor. In a further embodiment the functions may be implemented in a consumer electronics device.

Radio 1018 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In embodiments, display 1020 may comprise any television type monitor or display. Display 1020 may comprise, for example, a computer display screen, touch screen display, video monitor, television-like device, and/or a television. Display 1020 maybe digital and/or analog. In embodiments, display 1020 maybe a holographic display. Also, display 1020 may be a transparent surface that may receive a visual projection. Such projections may convey various forms of information, images, and/or objects. For example, such projections maybe a visual overlay for a mobile augmented reality (MAR) application. Under the control of one or more software applications 1016, platform 1002 may display user interface 1022 on display 1020.

In embodiments, content services device(s) 1030 maybe hosted by any national, international and/or independent service and thus accessible to platform 1002 via the Internet, far example. Content services device(s) 1 030 maybe coupled to platform 1002 and/or to display 1020. Platform 1002 and/or content services device(s) 10 30 maybe coupled to a network 1060 to communicate (e.g., send and/or receive) media information to and from network 1060. Content delivery device(s) 1040 also maybe coupled to platform 1002 and/or to display 1020.

In embodiments, content services device(s) 1030 may comprise a cable television box, personal computer, network telephone, Internet enabled devices or appliance capable of delivering digital information and/or content, and any other similar device capable of unidirectionally or bidirectionally communicating content between content providers and platform 1002 and/display 1020, via network 1060 or directly. It will be appreciated that the content maybe communicated unidirectionally and/or bidirectionally to and from any one of the components in system 100 0 and a content provider via network 1 060. Examples of content may include any media information including, for example, video, music, medical and gaming information, aid so forth.

Content services device(s) 1030 receives content such as cable television programming including media information, digital information, and/or other content. Examples of content providers may include any cable or satellite television or radio or Internet content providers. The provided examples are not meant to limit embodiments of the invention.

In embodiments, platform 1002 may receive control signals from navigation controller 1050 having one or more navigation features. The navigation features of controller 1050 may be used to interact with user interface 1022, for example. In embodiments, navigation controller 1050 maybe a minting device that maybe a computer hardware component (generally human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1 050 may be echoed on a display (e.g., display 1020) by move merits of a pointer, cursor, focus ring, or other visual indicators displayed on the display. For example, under the control of software applications 1016, fit navigation features located on navigation controller 1050 maybe mapped to virtual navigation features displayed on user interface 1022, for example. In embodiments, controller 1050 may not be a separate component but integrated into platform 1002 and/or display 1 020. Embodiments, however, are not limited to the elements or in the context shown or described herein.

In embodiments, drivers (not shown) may comprise technology to enable users to instantly turn on and off platform 1002 like a television with the touch of a button after initial boot-up, when enabled, for example. Program logic may allow platform 10 02 to stream content to media adaptors or other content services device(s) 1030 or content delivery device(s) 1040 when the platform is turned “off.” In addition, chip set 1005 may comprise hardware and/or software support for 5.1 sound sound audio and/or high definition 7.1 surround sound audio, for example. Drivers may include a graphics driver for integrated graphics platforms. In embodiments, the graphics driver may comprise a peripheral communication interconnect (PCI) Express graphics card.

In various embodiments, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002 and display 1020 maybe an integrated unit. Display 1020 and content service device(s) 1030 may be integrated, or display 1020 and content delivery device(s) 1040 maybe integrated, for example. The examples are not meant to limit the invention.

In various embodiments, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wind communications media, such as input/output (I/O) adapters, physical connectors to connect the I/O adapter with a corresponding wired communications medium, a network interface card (NIC), disc controller, video controller, audio controller, and so forth. Examples of wired communications media mag include a wire, cable, metal leads, printed circuit board (FCB), backplane, switch fabric, semiconductor material, twisted-pair wire, co-axial cable, fiber optics, and so forth.

Platform 1 002 may establish one or more logical or physical channels to communicate information The information may include media information and control information. Media information may refer to any data representing content Me ant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information maybe used to route media information through a system, or instruct a node to process the media information in a predetermined manner. The embodiments, however, are not limited to the elements or in the context shown or described in FIG. 10.

As described above, system 1000 may be embodied in varying physical sues or form factors. FIG. 11 illustrates embodiments of a small form factor device 1 100 in which system 1000 may be embodied. In embodiments, for example, device 1100 may be implemented as a mobile computing device having wireless capabilities. A mobile computing device may refer to any device having a processing system and a mobile power source or supply; such as ore or more batteries, for example.

As described above, examples of a mobile computing device may include a personal computer (FC), laptop computer, ultra-laptop computer, tablet touch pad, portable computer, handheld computer, palmtop computer, personal digital assistant (FDA), cellular telephone, combination cellular telephone/FDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device maybe implemented as a smart phone capable of executing computer applications, as well as voice communications and/or data communications. Although some embodiments may be described with a mobile compiling device implemented as a smart phone by my of example, it may be appreciated that other embodiments maybe implemented using other wireless mobile compiling devices as well. The embodiments are not limited in this context.

As shown in FIG. 11, device 1100 may comprise a housing 1102, a display 1104, an input/output (I/O) device 1106, and an antenna 1108. Device 1100 also may comprise navigation features 1112. Display 1104 may comprise any suitable display unit for displaying information appropriate for a mobile compiling device. In device 1106 may comprise any suitable I/O device for entering information into a mobile computing device. Examples for Ii0 device 110 6 may include an alphanumeric keyboard, a numeric keypad, a touch pad, input keys, button, switches, rocker switches, micro phones, speakers, voice recognition device and software, and so forth Information also maybe entered into device 1100 by way of microphone. Such information maybe digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chip, microchip, chip sets, and so forth. Examples of software may ire lode software components, programs, applications, computer programs, application programs, system programs, machine programs, operating system software, middleware, firmware, software modules, routines, subroutines, functions, methods, procedures, software interfaces, application program. interfaces (API), instruction sets, computing code, computer code, code segments, computer code segments, words, values, symbols, or any combination thereof. Determining whether an embodiment is implemented using hardware elements milk r software elements may vary in accordance with any number of factors, such as desired computational rate, power levels, heat tolerances, processing cycle budget, input data rates, output data rates, memory re sources, data bus speeds and other design or performance constraints.

One or more aspects of at least one embodiment maybe implemented by representative instructions stored on a machine -readable medium which represents various logic within the procescar, which when read by a machine causes the mac line to fabricate logic to perform the techniques described herein. Such representations, known as “IP cores” may be stored on a tangible, machine readable medium and supplied to various customers or manufacturing facilities to load into the fabrication machines that actually make the logic or processor.

In this specification, “a” and “an” and similar phrases are to be interpreted as “at least one” and “one or more.” References to “an” embodiment in this disclosure are not necessarily to the same embodiment.

Many of the elements described in the disclosed embodiments maybe implemented as modules. A module is defined here as an isolatable element that performs a defined function and may have a defined interface to other elements. The modules described in this disclosure maybe implemented in hardware, a combination of hardware and software, firmware, or a combination thereof, all of which are behaviorally equivalent. For example, modules maybe implemented using computer hardware in combination with software routine(s) written in a computer language (such as C, C++, Fortran, Java, Basic, Matlab or the like) or a modeling simulation program such as Similink Stateflow, GNU Octave, or LabVIEW MathScrirt. Additionally it maybe possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions maybe stored on a machine-readable medium. According to some embodiments, the machine-readable medium (e.g. automated data medium) maybe a medium configured to store data in a machine-readable format that may be accessed by an automated sensing device. Examples of machine-readable media include: magnetic disks, cards, tapes, and drums, punched cards and parer tapes, optical disks, barcodes, magnetic ink characters and/or the like.

In addition, it should be understood that any figures that highlight any functionality and/or advantages, are presented for example pinroses only The disclosed architecture is sufficiently flexible and configurable, such that it may be utilized in wags other than that shown. For example, the steps listed in any flown hut maybe re-ordered or only optionally use d in same embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chip, microchips, chip sets, and so forth. Examples of software may include software components, programs, applications, computer programs, application pro grants, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerares, processing cycle budget, input data rates, output data rates, memory resotuces, data bus speeds and other design or performance constraints.

One or more aspects of at least one embodiment maybe implemented by representative instructions stored on a machine -readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some maybe different, to indicate more constituent signal paths, have a number label, to indicate a number of constituent signal paths, and/or have arrows at one or more ends, to indicate primary information flow direction. This, however, should not be construed in a limiting maitre r. Rather, such added detail maybe used in connection with one or more exemplary embodiments to facilitate easier understanding of a circuit. Any represented signal lines, whether or not having additional information, may actually comprise one or more signals that may travel in multiple directions and maybe implemented with any suitable type of signal scheme, e.g., digital or analog lines implemented with differential pairs, optical fiber lines, and/or single -ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chip and other components may or may not be shown within the figures, for simplicity of illustration and discussion, and so as not to obscure certain aspects of the embodiments of the invention. Further, arrangements maybe shown in block diagram form in order to avoid obscuring embodiments of the invention, and also in view of the fact that specifics with respect to implementation of such block diagram arrangements are highly dependent upon the platform within which the embodiment is to be implemeplied, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, compiling platform, computing device, processing device, computing system, processing system, computer, processor, or the like, and maybe implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re writeable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, tinarnic code, encrypted code, and the like, implemented using any suitable high-level, low-level, object-oriented, visual, compiled and/or interpreted programming language.

Unless specifically stated otherwise, it maybe appreciated that terms such as “processing,” “computing,” “calculating,” “determining,” or the like, refer to the action and/or processes of a computer or computing system, or similar electronic compiling device, that manipulates and/or transforms data represented as physical quantities (e.g., electronic) within the computing system's registers and/or memories into other data similarly represented as physical quantities within the compiling system's memories, registers or other such information storage, transmission or display devices. The embodiments are not limited in this context.

TIE term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. maybe used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof; the true scope of the embodiments of the invention should not be so limited since other modifications will become apparent to the skilled practitioner upon a study of the drawings, specification, and following claims.

1-30. (canceled)

31. A method comprising:
generating a number of initial reconstructed macro block lines by encoding the number of initial reconstructed macro block lines from a first buffer holding a current frame having a number of lines;
placing the number of initial reconstructed macro block lines in a first in first out buffer sized to hold the number of initial reconstructed macro block lines; and
incrementally, until all the number of lines in the current frame have been processed:
generating an additional reconstructed macro block line by encoding the next line in the current frame using at least one reconstructed macro block line in the first in first out buffer;
placing, sequentially in a reference buffer, a reconstructed macro block line pulled from the tail of the first in first out buffer; and
pushing the additional reconstructed macro block line onto the head of the first in first out buffer.

32. The method according to claim 31, further including generating an additional reconstructed macro block line using the next line in the current frame and each reconstructed macro block line in the first in first out buffer.

33. The method according to claim 31, wherein the number of initial reconstructed macro block lines is three.

34. The method according to claim 31, wherein the first in first out buffer is part of a reference buffer.

35. The method according to claim 31, wherein the reference buffer is one or more of a previous frame and an alternate frame.

36. The method according to claim 31, wherein the current frame is a non-key frame.

37. An apparatus comprising:
a first buffer to hold a current frame, the current frame having a number of lines;
a line encoder to generate a reconstructed macro block line for each of the number of lines;
a first in first out buffer sized to hold a number of reconstructed macro block lines; and
a reference buffer to hold reconstructed macro block lines output from the first in first out buffer.

38. The apparatus according to claim 37, wherein the current frame is a non-key frame.

39. The apparatus according to claim 37, wherein the line encoder generates each encoded line using a current line from the current frame and at least one encoded line in the first in first out buffer.

40. The apparatus according to claim 37, wherein the line encoder generates each reconstructed macro block line using a current line from the current frame and one or more reconstructed macro block lines in the first in first out buffer.

41. The apparatus according to claim 37, wherein the number of reconstructed macro block lines is three.

42. The apparatus according to claim 37, wherein the line encoder is part of a VP8 encoder.

43. The apparatus according to claim 37, wherein the first in first out buffer is part of a reference buffer.

44. The apparatus according to claim 43, wherein the reference buffer is one or more of a previous frame and an alternate frame.

45. A system comprising:
a video input;
an encoder including:
a first buffer to hold a current frame, the current frame having a number of lines;
a line encoder to generate a reconstructed macro block line for each of the number of lines;
a first in first out buffer sized to hold a number of reconstructed macro block lines; and
a reference buffer to hold reconstructed macro block lines output from the first in first out buffer; and
an encoded video output to output an encoded video stream.

46. The system according to claim 45, wherein the current frame is a non-key frame.

47. The system according to claim 45, wherein the line encoder generates each encoded line using a current line from the current frame and at least one encoded line in the first in first out buffer.

48. The system according to claim 45, wherein the line encoder generates each reconstructed macro block line using a current line from the current frame and one or more reconstructed macro block lines in the first in first out buffer.

49. The system according to 45, wherein the number of reconstructed macro block lines is three.

50. The system according to claim 45, wherein the line encoder is part of a VP8 encoder.

51. The system according to claim 45, wherein the first in first out buffer is part of a reference buffer.

52. At least one non-transitory machine-readable medium comprising one or more instructions, which, if executed by a processor, cause a computer to:
generate a number of initial reconstructed macro block lines by encoding the number of initial reconstructed macro block lines from a first buffer holding a current frame having a number of lines;
place the number of initial reconstructed macro block lines in a first in first out buffer sized to hold the number of initial reconstructed macro block lines; and
incrementally, until all the number of lines in the current frame have been processed:
generate an additional reconstructed macro block line by encoding the next line in the current frame using at least one reconstructed macro block line in the first in first out buffer;
place, sequentially in a reference buffer, a reconstructed macro block line pulled from the tail of the first in first out buffer; and
push the additional reconstructed macro block line onto the head of the first in first out buffer.

53. The medium according to claim 52, wherein the instructions, if executed, further cause the computer to generate an additional reconstructed macro block line using the next line in the current frame and each reconstructed macro block line in the first in first out buffer.

54. The medium according to claim 52, wherein number of initial reconstructed macro block lines is three.

55. The medium according to claim 52, wherein number of initial reconstructed macro block lines is sixteen.

56. The medium according to claim 52, wherein the current frame is video frame.

57. The medium according to claim 52, wherein the line encoder is part of a VP8 encoder.

58. The medium according to claim 52, wherein the first in first out buffer is part of a reference buffer.

59. The medium according to claim 58, wherein the reference buffer is one or more of a previous frame and an alternate frame.

60. The medium according to claim 52, wherein the current frame is a non-key frame.
